(19) United States
(12) Patent Application Publication
(10) Pub. No.: US 2015/0123975 A1
(43) Pub. Date: May 7, 2015

(54) Visualization Method Of Numerical Weather Prediction Model Data On Six-Panels Grid Frame And Hardware Device Performing The Same

(71) Applicant: Korea Institute of Atmospheric Prediction Systems, Seoul (KR)

(72) Inventors: Dong-Chan JOO, Seoul (KR); Ki-Hwan KIM, Seoul (KR); Seol-Eun SHIN, Seoul (KR)

(21) Appl. No.: 14/080,057

(22) Filed: Nov. 14, 2013

(30) Foreign Application Priority Data
Nov. 7, 2013 (KR) 10-2013-0134662

(51) Int. Cl. G06T 11/20

(52) U.S. Cl. CPC G06T 11/206; G06T 11/203
USPC 345/440

(57) ABSTRACT

A method of visualizing numerical weather prediction model data on a six-panel grid frame is disclosed. Global map data are converted from latitude-longitude coordinates into coordinates in the six-panel grid frame. The six-panel grid frame are provided with numerical weather prediction model data in a first cubed-sphere coordinates system. The numerical weather prediction model data are displayed on the six-panel grid frame. The six-panel grid frame includes expanded six faces of a virtual cube. Each face of the expanded six faces is defined by four sub-faces of eight sub-cubes which are assembled with each other within the virtual cube.

### TECHNICAL FIELD

Example embodiments of the invention relate to a visualization method of numerical weather prediction model data and a hardware device performing the same. More particularly, example embodiments of the invention relate to a visualization method of numerical weather prediction model data on a six-panel grid frame and a hardware device performing the same.

### DESCRIPTION OF THE RELATED ART

A numerical weather prediction (“NWP”) model is a mathematical model to compute a plurality of equations including dynamic equations and physical parameterization equations of atmosphere and ocean in order to predict a future weather condition from current or past weather conditions. The NWP model may include a dynamic core part which is important to compute the dynamic equations. The dynamic core part may describe physical quantities such as, e.g., wind, temperature, pressure, humidity, entropy, etc. as primitive equations including a plurality of partial differential equations. The dynamic core part may numerically solve a solution of the primitive equations.

A computation method for the partial differential equations may be required to compute the primitive equations as well as information on positions of variables in the primitive equations. The information on positions of variables in the primitive equations may be acquired using a spherical coordinates system to indicate horizontal and vertical positions on the Earth. For example, a conventional latitude-longitude coordinates system may be used to indicate horizontal positions of the variables. Also, a vertical coordinates system such as, e.g., a pressure height, or a sea surface height may be used to indicate vertical positions of the variables.

The computation method for the partial differential equations may include a spectral element method. The spectral element method may divide a whole computational space into a plurality of element spaces, expand Legendre polynomials or Lagrange polynomials in each of the element spaces, and compute a numerical solution of the partial differential equations.

Technologies have been developed to use a cubed-sphere grid system to compute the numerical solution of the partial differential equations. The cubed-sphere grid system may reduce a difference between grid point distribution in a polar region and that in an equatorial region.

### CONTENT OF THE INVENTION

### Technical Object of the Invention

One or more example embodiment of the invention provides a visualization method of numerical weather prediction model data in a cubed-sphere coordinates system on a six-panel grid frame without additional coordinates conversion of the numerical weather prediction model data.

Also, another example embodiment of the invention provides a hardware device performing the visualization method of numerical weather prediction model data on a six-panel grid frame.

### Construction and Operation of the Invention

In an example embodiment of a visualization method of numerical weather prediction model data in a cubed-sphere coordinates system on a six-panel grid frame, global map data are converted from latitude-longitude coordinates into coordinates in the six-panel grid frame. The six-panel grid frame is provided with numerical weather prediction model data in a first cubed-sphere coordinates system. The numerical weather prediction model data are displayed on the six-panel grid frame. The six-panel grid frame includes expanded six faces of a virtual cube. Each face of the expanded six faces is defined by four sub-faces of eight sub-cubes which are assembled with each other within the virtual cube. Each of the sub-cubes includes a first vertex, a second vertex, a third vertex and a fourth vertex. The second vertex, the third vertex and the fourth vertex are spaced apart from a center of Earth by a predetermined distance along an x-axis, a y-axis and a z-axis respectively, in a positive direction or in a negative direction. The first vertex is the center of the Earth. The x-axis, the y-axis and the z-axis are axes in a three-dimensional Cartesian coordinates system. The x-axis starts from the center of the Earth to penetrate a first point on a surface of the Earth. The y-axis is perpendicular to the x-axis in a latitude direction or in a longitude direction with respect to the first point. The z-axis is perpendicular to both of the x-axis and the y-axis.

In an example embodiment, the converting the global map data from the latitude-longitude coordinates system into coordinates in the six-panel grid frame may include providing global coastline position data in a latitude-longitude coordinates system and converting the global coastline position data from the latitude-longitude coordinates into coordinates in the six-panel grid frame.

In an example embodiment, the providing the six-panel grid frame with the numerical weather prediction model data in the first cubed-sphere coordinates system may include adjusting a first grid resolution of the first cubed-sphere coordinates system to a second grid resolution of a second cubed-sphere coordinates system. The global map data may be defined in the second cubed-sphere coordinates system.

In an example embodiment, the first point may be an intersection point at which an equator and a prime meridian cross.

In an example embodiment, the six-panel grid frame may include a first face representing a first region which is between −45 degrees and +45 degrees in latitude and between zero degree and +45 degrees or between +315 degrees and +360 degrees in longitude. The six-panel grid frame may further include a second face representing a second region which is between −45 degrees and +45 degrees in latitude and between +45 degrees and +135 degrees in longitude. The six-panel grid frame may further include a third face representing a third region which is between −45 degrees and +45 degrees in latitude and between +135 degrees and +225 degrees in longitude. The six-panel grid frame may further include a fourth face representing a fourth region which is between −45 degrees and +45 degrees in latitude and between +225 degrees and +315 degrees in longitude. The six-panel grid frame may further include a fifth face representing a fifth region which is between +45 degrees and +90 degrees in latitude and between zero degree and +360 degrees in longitude. The six-panel grid frame may further include a sixth face representing a sixth region which is between −90 degrees and −45 degrees in latitude and between zero degree and +360 degrees in longitude.

In an example embodiment of a hardware device performing a visualization method of numerical weather prediction model data in a cubed-sphere coordinates system on a six-panel grid frame, the hardware device may include a memory, a computation part and a display part. The memory is configured to store global map data in a latitude-longitude coordinates system. The computation part is configured to convert the global map data from latitude-longitude coordinates into coordinates in a six-panel grid frame. The computation part is further configured to provide the six-panel grid frame with numerical weather prediction model data in a first cubed-sphere coordinates system. The display part is configured to display the numerical weather prediction model data on the six-panel grid frame. The six-panel grid frame includes expanded six faces of a virtual cube. Each face of the expanded six faces is defined by four sub-faces of eight sub-cubes which are assembled with each other within the virtual cube. Each of the sub-cubes includes a first vertex, a second vertex, a third vertex and a fourth vertex. The second vertex, the third vertex and the fourth vertex are spaced apart from a center of Earth by a predetermined distance along an x-axis, a y-axis and a z-axis respectively, in a positive direction or in a negative direction. The first vertex is the center of the Earth. The x-axis, the y-axis and the z-axis are axes in a three-dimensional Cartesian coordinates system. The x-axis starts from the center of the Earth to penetrate a first point on a surface of the Earth. The y-axis is perpendicular to the x-axis in a latitude direction or in a longitude direction with respect to the first point. The z-axis is perpendicular to both of the x-axis and the y-axis.

In an example embodiment, the computation part may be further configured to receive global coastline position data in the latitude-longitude coordinates system from the memory and convert the global coastline position data into coordinates in a second cubed-sphere coordinates system.

In an example embodiment, the computation part may be further configured to adjust a first grid resolution of the first cubed-sphere coordinates system to a second grid resolution of the second cubed-sphere coordinates system.

In an example embodiment, the first point may be an intersection point at which an equator and a prime meridian cross.

In an example embodiment, the six-panel grid frame may include a first face representing a first region which is between −45 degrees and +45 degrees in latitude and between zero degree and +45 degrees or between +315 degrees and +360 degrees in longitude. The six-panel grid frame may further include a second face representing a second region which is between −45 degrees and +45 degrees in latitude and between +45 degrees and +135 degrees in longitude. The six-panel grid frame may further include a third face representing a third region which is between −45 degrees and +45 degrees in latitude and between +135 degrees and +225 degrees in longitude. The six-panel grid frame may further include a fourth face representing a fourth region which is between −45 degrees and +45 degrees in latitude and between +225 degrees and +315 degrees in longitude. The six-panel grid frame may further include a fifth face representing a fifth region which is between +45 degrees and +90 degrees in latitude and between zero degree and +360 degrees in longitude. The six-panel grid frame may further include a sixth face representing a sixth region which is between −90 degrees and −45 degrees in latitude and between zero degree and +360 degrees in longitude.

### Effect of the Invention

According to one or more example embodiment of the visualization method of numerical weather prediction model data on the six-panel grid frame and the hardware device performing the same, the numerical weather prediction model data which are computed in the cubed-sphere coordinates system may be displayed on the six-panel grid frame to which faces of the virtual cube in the cubed-sphere coordinates system expanded, thereby easily representing the numerical weather prediction model data without any additional coordinates conversion.

Also, an additional interpolation and/or extrapolation process may not be required to visualize the numerical weather prediction model data in the cubed-sphere coordinates system on an expanded plan view, thereby improving accuracy of the numerical weather prediction model data represented on the expanded plan view.

### BRIEF EXPLANATION OF THE DRAWINGS

The above and other features and advantages of the invention will become more apparent by describing in detailed example embodiments thereof with reference to the accompanying drawings, in which:

FIG. 1 is a block diagram illustrating a hardware device performing a method of visualizing numerical weather prediction model data on a six-panel grid frame according to an example embodiment of the invention;

FIG. 2A is a perspective view illustrating a latitude-longitude coordinates system;

FIG. 2B is a plan view illustrating grid points of the latitude-longitude coordinates system of FIG. 2A;

FIG. 2C is a plan view illustrating a global distribution of a physical quantity in atmosphere using the latitude-longitude coordinates system of FIG. 2A;

FIG. 3A is a perspective view illustrating a cubed-sphere coordinates system which may be used in the hardware device illustrated in FIG. 1 according to an example embodiment;

FIG. 3B is a perspective view illustrating grid points of the cubed-sphere coordinates system of FIG. 3A;

FIG. 3C is a plan view illustrating the grid points of the cubed-sphere coordinates system of FIG. 3B;

FIG. 4 is a flowchart illustrating a method of visualizing numerical weather prediction model data on a six-panel grid frame according to an example embodiment;

FIG. 5 is a flowchart illustrating a conversion of global map data in a latitude-longitude coordinates system into the cubed-sphere coordinates system according to an example embodiment;

FIG. 6A and FIG. 6B are perspective views illustrating coordinates axes of the cubed-coordinates system according to an example embodiment;

FIG. 7 is an expanded plan view illustrating global map data on a six-panel grid frame according to an example embodiment; and

FIG. 8 is an expanded plan view illustrating a global distribution of a physical quantity in atmosphere using a six-panel grid frame according to an example embodiment.

### DETAILED DESCRIPTION OF THE INVENTION

Various example embodiments will be described more fully hereinafter with reference to the accompanying drawings, in which example embodiments are shown. Example embodiments may, however, be embodied in many different forms and should not be construed as limited to example embodiments set forth herein. Rather, these example embodiments are provided so that this disclosure will be thorough and complete, and will fully convey the scope of example embodiments to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the invention will be described in further detail with reference to the accompanying drawings.

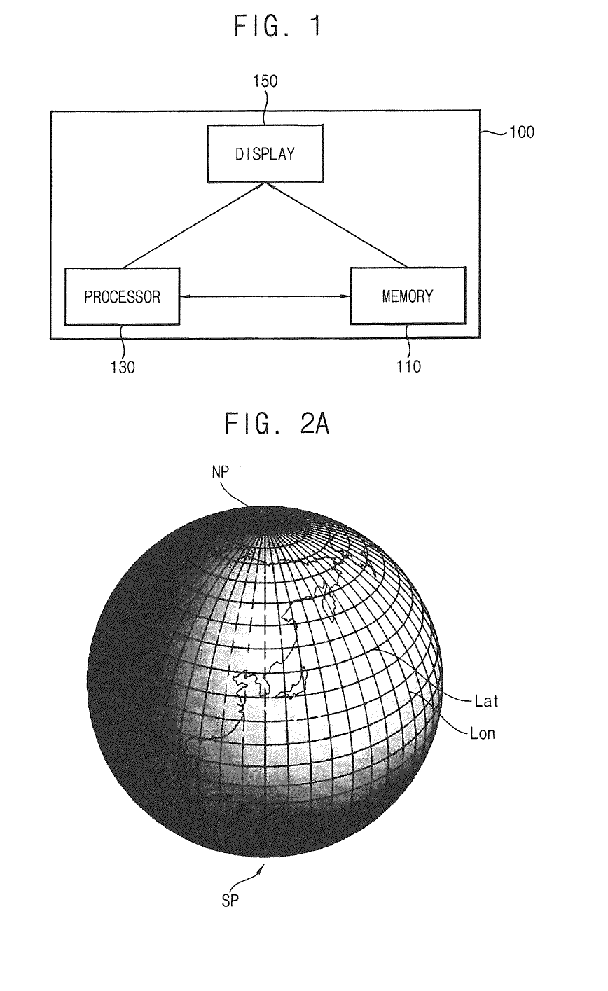

FIG. 1 is a block diagram illustrating a hardware device performing a method of visualizing numerical weather prediction model data on a six-panel grid frame according to an example embodiment of the invention.

Referring to FIG. 1, a hardware device 100 performing a method of visualizing numerical weather prediction model data on a six-panel grid frame according to the present example embodiment may include a memory 110, a computation part 130 and a display part 130. The memory 110 and the computation part 130 may include a server including a plurality of central processing units (CPUs) and a buffer memory. For example, the computation part 130 may include a plurality of CPUs configured to communicate with one another. For example, the computation part 130 may include thousands of or millions of CPUs. The memory 110 and the communication part 130 may be electrically connected to each other. The display part 150 may be configured to display a desired result which is computed in the computation part 130 or stored in the memory 110.

The computation part 130 may be configured to numerically compute a plurality of partial differential equations in a numerical weather prediction model. For example, the computation part 130 may be configured to compute an atmospheric-oceanic dynamic equation to generate a desired value of a physical quantity such as, e.g., temperature, wind, humidity, entropy, etc. at a predetermined time step.

The display part 150 may include, for example, a liquid crystal display device, an organic light emitting display device, etc. The liquid crystal display (LCD) device may include a liquid crystal display panel and a backlight assembly. The liquid crystal display panel may include a first array substrate, a first opposing substrate and a liquid crystal layer therebetween. The backlight assembly may be configured to generate light toward the liquid crystal display panel. The first array substrate may include a plurality of gate lines, a plurality of data lines, a plurality of first switching elements and a plurality of pixel electrodes. The desired result which is computed in the computation part 130 or stored in the memory 110 may be applied to the gate lines and the data lines as electrical signals via a first image driving part. Accordingly, liquid crystal molecules in the liquid crystal layer may be may be aligned to adjust luminance of the light from the backlight assembly, thereby displaying a color image or a black-and-white image.

The organic light emitting display (OLED) device may include a second array substrate, a plurality of organic light emitting display elements and a second opposing substrate. The organic light emitting display elements may be disposed on the second array substrate. The second opposing substrate may encapsulate the organic light emitting display elements. The second array substrate may include the gate lines, the data lines and a plurality of second switching elements which are electrically connected to the organic light emitting display elements. The desired result which is computed in the computation part 130 or stored in the memory 110 may be applied to the gate lines and the data lines as electrical signals via a second image driving part. Accordingly, a desired color light may be generated from the organic light emitting display elements to display a color image.

Although the memory 110, the computation part 130 and the display part 150 are illustrated in a single hardware device 100 in FIG. 1, the display part 150 may be disposed in another display space to be electrically connected to the memory 110 or the computation part 130 in another example embodiment.

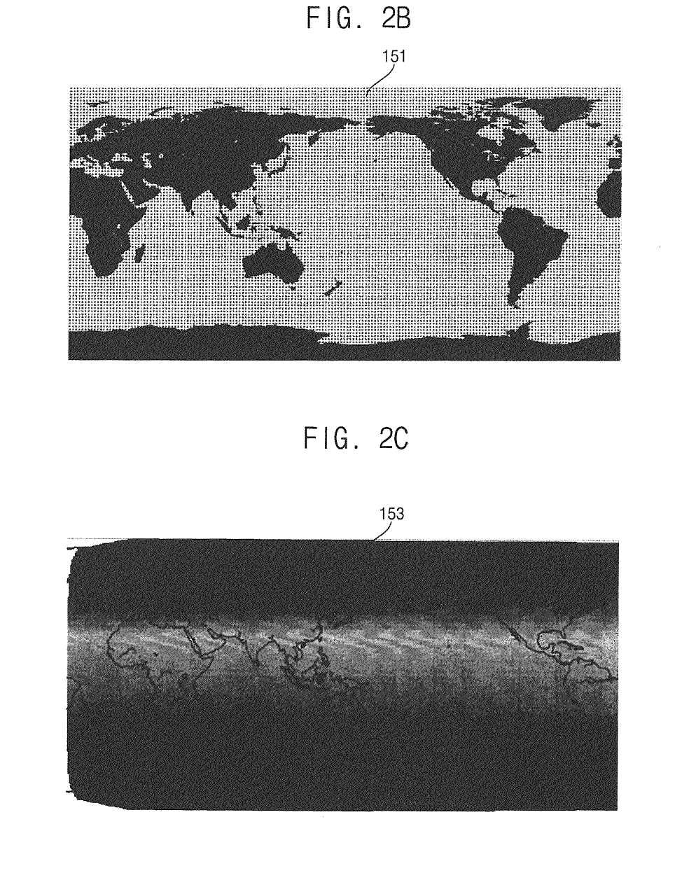

FIG. 2A is a perspective view illustrating a latitude-longitude coordinates system.

Referring to FIG. 2A, the hardware device 100 may implement a numerical weather prediction model using a conventional latitude-longitude coordinates system. The latitude-longitude coordinates system may include a plurality of longitude lines Lon and a plurality of latitude lines Lat. The longitude lines Lon may be defined by great circles crossing a North Pole NP and a South Pole SP. The latitude lines Lat may be defined by circles having degrees from zero at an equator to ±90 at the North Pole NP or at the South Pole SP. For example, the Korean Peninsula may include a geographical point located in 127.5 degrees east and 38 degrees north. In a conventional numerical weather prediction model, equations of atmospheric and/or oceanic physical quantities may be numerically computed based on the latitude-longitude coordinates system.

FIG. 2B is a plan view illustrating grid points of the latitude-longitude coordinates system of FIG. 2A.

Referring to FIG. 2B, grid points in the latitude-longitude coordinates system may be arranged substantially in a regular matrix shape in a plan view. Hereinafter, the plan view including the grid points in the latitude-longitude coordinates system may be referred as a “latitude-longitude grid frame” 151. In the latitude-longitude grid frame 151, the grid points may be arranged in a latitude direction and in a longitude direction. An observer may detect a global distribution of a physical quantity using the latitude-longitude grid frame 151. However, grid areas in a polar region may be enlarged than actual geographical areas due to a difference in a grid resolution between the polar region and an equatorial region. The grid resolution in the equatorial region may be lower than the grid resolution in the polar region.

FIG. 2C is a plan view illustrating a global distribution of a physical quantity in atmosphere using the latitude-longitude coordinates system of FIG. 2A.

Referring to FIG. 2B and FIG. 2C, the display part 150 may display desired values of the physical quantity such as, e.g., temperature, wind, humidity, entropy, etc. at each of the grid points of the latitude-longitude grid frame 151. The desired values may be visualized by a variety of ways such as, isopleths, shading, hue, etc. For example, the desired values may be visualized by a plan view 153 including different hues. In this case, a polar region in the plan view 153 may be relatively enlarged more than an equatorial region in the plan view 153 due to the difference in the grid resolution thereof.

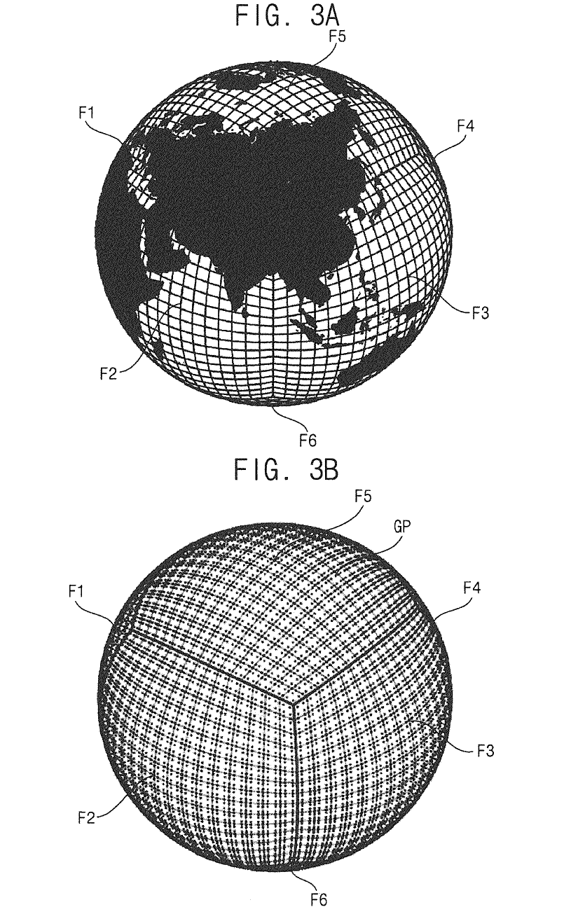

FIG. 3A is a perspective view illustrating a cubed-sphere coordinates system which may be used in the hardware device illustrated in FIG. 1 according to an example embodiment.

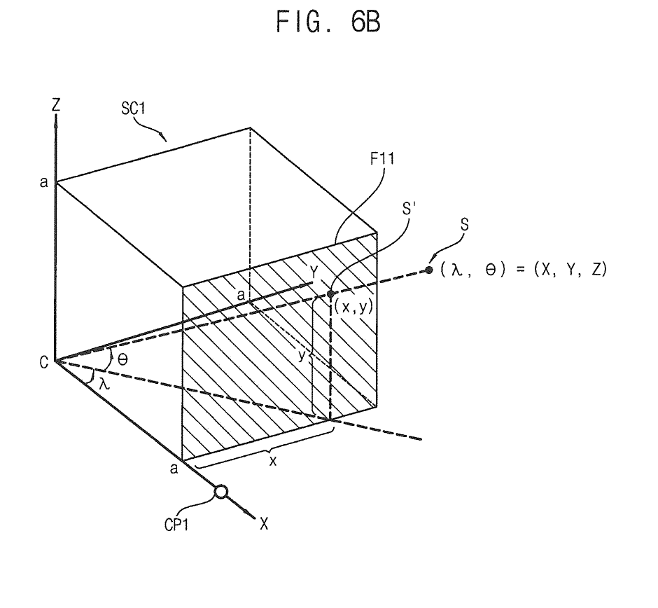

Referring to FIG. 3A, the hardware device 100 may compute and/or receive numerical weather prediction model data in a cubed-sphere coordinates system instead of the latitude-longitude coordinates system. The cubed-sphere coordinates system may include six faces on Earth's surface. The cubed-sphere coordinates system may include a plurality of abscissa grid lines extending in a first direction and a plurality of ordinate grid lines extending in a second direction which crosses the first direction in each face of the six faces. The first direction may be substantially perpendicular to the second direction on a virtual face of a virtual cube within the Earth. For example, the cubed-sphere coordinates system may include a first face F1 in which an intersection point of an equator and a prime meridian is centered. The cubed-sphere coordinates system may include a second face F2, a third face F3 and a fourth face F4 sequentially disposed adjacent to the first face F1 along a rotational direction of the Earth. The cubed-sphere coordinates system may include a fifth face F5 in which the North Pole NP is centered. The cubed-sphere coordinates system may include a sixth face F6 in which the South Pole SP is centered. Each of the faces F1, F2, F3, F4, F5 and F6 may be defined based on a gnomonic projection. The cubed-sphere coordinates system will be further described in detail referring to FIG. 6.

FIG. 3B is a perspective view illustrating grid points of the cubed-sphere coordinates system of FIG. 3A.

Referring to FIG. 3A and FIG. 3B, grid points GP in the cubed-sphere coordinates system may be uniformly distributed in each of the faces F1, F2, F3, F4, F5 and F6. A number of the grid points GP in the polar region may be substantially the same as a number of the grid points GP in the equatorial region in the cubed-sphere coordinates system. Accordingly, the grid resolution in the polar region may be substantially the same as the grid resolution in the equatorial region.

FIG. 3C is a plan view illustrating the grid points of the cubed-sphere coordinates system of FIG. 3B.

Referring to FIG. 3C, the grid points GP in each of the faces F1, F2, F3, F4, F5 and F6 illustrated in FIG. 3B may be represented in a plan view. In the plan view of the grid points GP in the cubed-sphere coordinates system, grid resolutions in the fifth face F5 and the sixth face F6 may seem to be relatively lower than grid resolutions in the first face F1, the second face F2, the third face F3 and the fourth face F4 due to an enlargement of geographical areas in the polar region in the plan view.

As mentioned above, the difference in grid resolutions between the polar region and the equatorial region may occur on an actual Earth's surface if the grid resolution represented in the plan view of the Earth's surface is relatively uniform (i.e., in the latitude-longitude coordinates system). Also, the difference in grid resolutions between the polar region and the equatorial region may occur in a plan view of the Earth's surface if the grid resolution represented in the actual Earth's surface is relatively uniform (i.e., in the cubed-sphere coordinates system).

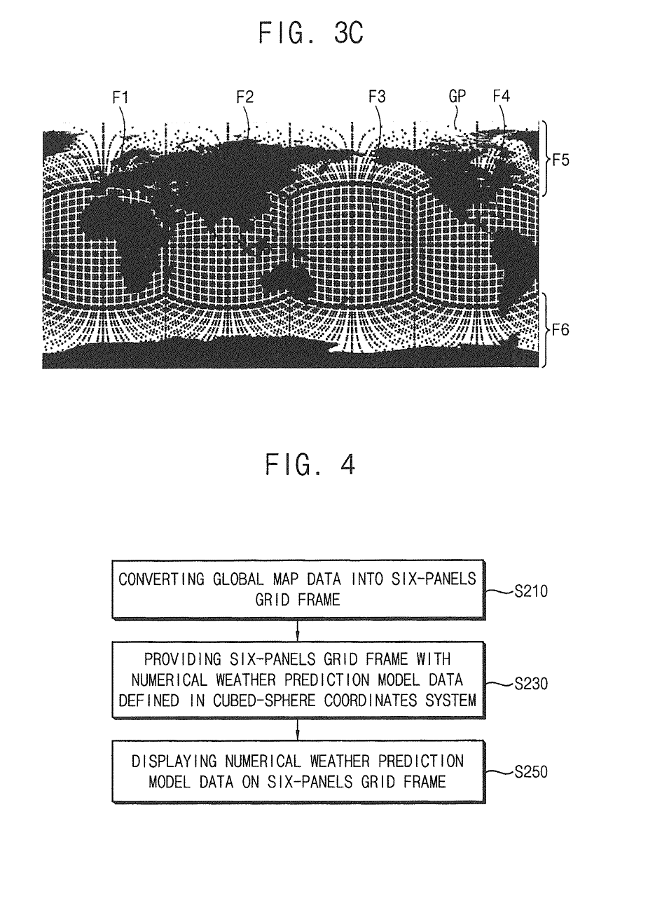

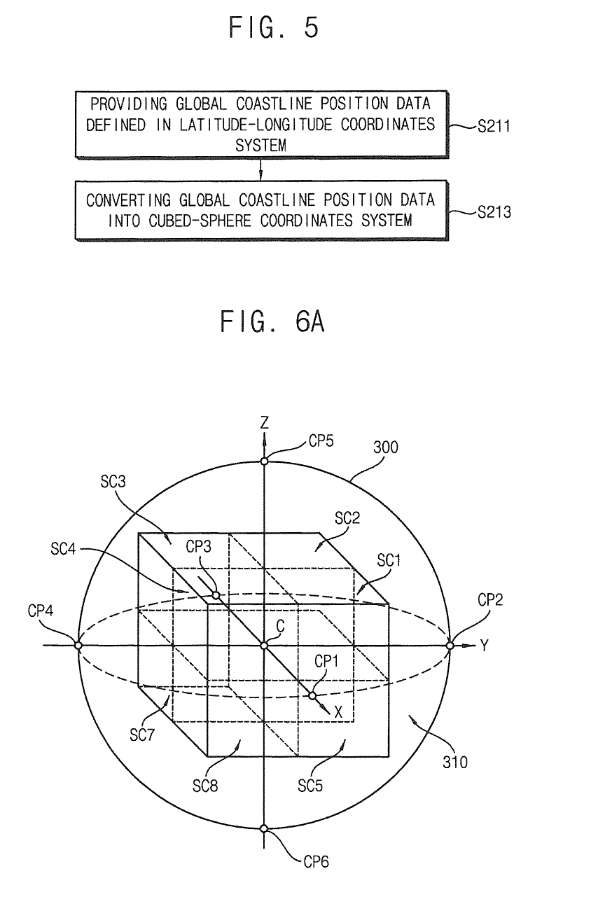

FIG. 4 is a flowchart illustrating a method of visualizing numerical weather prediction model data on a six-panel grid frame according to an example embodiment. FIG. 5 is a flowchart illustrating a conversion of global map data in a latitude-longitude coordinates system into the cubed-sphere coordinates system according to an example embodiment.

Referring to FIG. 4 and FIG. 5, in a method of visualizing numerical weather prediction model data on a six-panel grid frame according to the present example embodiment, global map data may be converted to coordinates in the six-panel grid frame in a step S210. Numerical weather prediction model data in a cubed-sphere coordinates system may be provided in the six-panel grid frame in a step S230. The numerical weather prediction model data may be displayed on the six-panel grid frame in a step S250. In a first step S211 of the step S210, global coastline position data may be provided in a latitude-longitude coordinates system. In a second step S213 of the step S210, the global coastline position data may be converted into coordinates in the cubed-sphere coordinates system.

In the present example embodiment, each of the steps S210, S211, S213, S230 and S250 may be performed in the memory 110, the computation part 130 and/or the display part 150 illustrated in FIG. 1. Hereinafter, each of the steps S210, S211, S213, S230 and S250 will be described in detail.

FIG. 6A and FIG. 6B are perspective views illustrating coordinates axes of the cubed-coordinates system according to an example embodiment.

Referring to FIG. 1, FIG. 5 and FIG. 6A, the global map data may be converted to coordinates in the six-panel grid frame in the step S210. For example, in the first step S211 of the step S210, the global coastline position data may be provided in the latitude-longitude coordinates system. For example, in the second step S213 of the step S210, the global coastline position data may be converted into coordinates in the cubed-sphere coordinates system.

In the first step S211, the global coastline position data stored in the memory 110 may be provided to the computation part 130. The computation part 130 may be configured to convert the global coastline position data having latitude-longitude coordinates into cubed-sphere coordinates.

Referring to FIG. 6A, the cubed-sphere coordinates of the global coastline position data on the Earth's surface 300 may be represented in a three-dimensional Cartesian coordinates system. Coordinates in the three-dimensional Cartesian coordinates system may be represented in a two-dimensional Cartesian coordinates system in six faces of the cubed-sphere coordinates system. For example, the three-dimensional Cartesian coordinates system may be defined by an x-axis, a y-axis and a z-axis. The x-axis may start from a center C of the Earth to penetrate a first face center CP1. For example, the first face center CP1 may be an intersection point at which the equator and the prime meridian cross. The y-axis may start from the center C of the Earth to penetrate a second face center CP2. The second face center CP2 may be an intersection point at which the equator and a +90 longitude line cross. The z-axis may start from the center C of the Earth to penetrate a fifth face center CP5. The fifth face center CP5 may be, e.g., the North Pole. In a similar manner, a third face center CP3 may be defined by an intersection point at which the x-axis crosses the Earth's surface 300 in a negative direction. A fourth face center CP4 may be defined by an intersection point at which the y-axis crosses the Earth's surface 300 in a negative direction. A sixth face center CP6 may be defined by the South Pole. In this case, a virtual cube 310 may be defined based on the first face center CP1, the second face center CP2, the third face center CP3, the fourth face center CP4, the fifth face center CP5 and the sixth face center CP6. Each of the face centers CP1, CP2, CP3, CP4, CP5 and CP6 may be projected on a center of six faces of the virtual cube 310 along the x-axis, the y-axis and the z-axis. A side of the virtual cube 310 may have a 2 times “a” in length, where “a” represents an arbitrary positive real number. The virtual cube 310 may include eight sub-cubes SC1, SC2, SC3, SC4, SC5, SC6, SC7 and SC8 which are divided by an XY-plane, an YZ-plane and a ZX-plane.

Referring to FIG. 6B, a first point S on the Earth's surface 300 may be represented by coordinates of (π, θ) in a latitude-longitude coordinates system. The first point S may be located on a longitude line having an angle λ with respect to the x-axis and a latitude line having an angle θ with respect to the x-axis. Also, the first point S may be represented by coordinates of (X, Y, Z) based on a distance of large “X” along the x-axis, a distance of large “Y” along the y-axis and a distance of large “Z” along the z-axis from the center C of the Earth in the three-dimensional Cartesian coordinates system. In this case, three-dimensional Cartesian coordinates (X, Y, Z) of the first point S may be represented by the angle λ and the angle θ as Equation 1:

$$\{ \begin{matrix}X = R cos θ cos λ \\ Y = R cos θ sin λ \\ Z = R sin θ\end{matrix} . \qquad [ Equation 1 ]$$

Here, R represents a radius of the Earth which is constant.

If a length “a” of a side of a first sub-cube SC1 is shorter than the radius of the Earth, then an intersection point S′ at which a line connecting the center of the Earth and the first point S crosses the first sub-cube SC1 may be represented by small “x” distance along the y-axis and small “y” distance along the z-axis. In a cubed-sphere coordinates system, a first point S on the Earth's surface 300 may be projected onto a first sub-face F11 of the first sub-cube SC1 as the intersection point S′ which has coordinates of (x, y). The first sub-face F11 of the first sub-cube SC1 may be correspond to a region which is between zero degree and +45 degrees in latitude and between zero degree and +45 degrees in longitude on the Earth's surface 300. The three-dimensional Cartesian coordinates (X, Y, Z) may be converted into two-dimensional Cartesian coordinates (x, y) on the first sub-face F11 as Equation 2:

$$\frac{x}{a} = \frac{Y}{X} , \frac{y}{x} = \frac{Z}{Y} \\ x = a \frac{Y}{X} , y = a \frac{Z}{X} . \qquad [ Equation 2 ]$$

The Equation 2 may be applied to an arbitrary point located in a first region which is between −45 degrees and +45 degrees in latitude and between zero degree and +45 degrees or between +315 degrees and +360 degrees in longitude. The arbitrary point in the first region may correspond to a first face F1 of the virtual cube 310.

Similarly, an arbitrary point located in a second region which is between −45 degrees and +45 degrees in latitude and between +45 degrees and +135 degrees in longitude may be represented by two-dimensional Cartesian coordinates on the virtual cube 310 as Equation 3:

$$\frac{x}{a} = \frac{- X}{Y} , \frac{y}{x} = \frac{Z}{- X} \\ x = - a \frac{X}{Y} , y = a \frac{Z}{Y} . \qquad [ Equation 3 ]$$

The arbitrary point located in the second region may correspond to a second face F2 of the virtual cube 310.

Similarly, an arbitrary point located in a third region which is between −45 degrees and +45 degrees in latitude and between +135 degrees and +225 degrees in longitude may be represented by two-dimensional Cartesian coordinates on the virtual cube 310 as Equation 4:

$$\frac{x}{a} = \frac{- Y}{- X} , \frac{y}{x} = \frac{Z}{- Y} \\ x = a \frac{Y}{X} , y = - a \frac{Z}{X} . \qquad [ Equation 4 ]$$

The arbitrary point located in the third region may correspond to a third face F3 of the virtual cube 310.

Similarly, an arbitrary point located in a fourth region which is between −45 degrees and +45 degrees in latitude and between +225 degrees and +315 degrees in longitude may be represented by two-dimensional Cartesian coordinates on the virtual cube 310 as Equation 5:

$$\frac{x}{a} = \frac{X}{- Y} , \frac{y}{x} = \frac{Z}{X} \\ x = - a \frac{X}{Y} , y = - a \frac{Z}{Y} . \qquad [ Equation 5 ]$$

The arbitrary point located in the fourth region may correspond to a fourth face F4 of the virtual cube 310.

Similarly, an arbitrary point located in a fifth region which is between +45 degrees and +90 degrees in latitude and between zero degree and +360 degree in longitude may be represented by two-dimensional Cartesian coordinates on the virtual cube 310 as Equation 6:

$$\frac{x}{a} = \frac{Y}{- Z} , \frac{y}{x} = \frac{X}{Y} \\ x = - a \frac{Y}{Z} , y = - a \frac{X}{Z} . \qquad [ Equation 6 ]$$

The arbitrary point located in the fifth region may correspond to a fifth face F5 of the virtual cube 310.

Similarly, an arbitrary point located in a sixth region which is between −90 degrees and −45 degrees in latitude and between zero degree and +360 degree in longitude may be represented by two-dimensional Cartesian coordinates on the virtual cube 310 as Equation 7:

$$\frac{x}{a} = \frac{Y}{- Z} , \frac{y}{x} = \frac{X}{Y} \\ x = - a \frac{Y}{Z} , y = - a \frac{X}{Z} . \qquad [ Equation 7 ]$$

The arbitrary point located in the sixth region may correspond to a sixth face F6 of the virtual cube 310.

As mentioned above, an arbitrary point on the Earth's surface 300 may be represented by two-dimensional Cartesian coordinates on each of the faces F1, F2, F3, F4, F5 and F6 of the virtual cube 310 based on the Equation 1 through the Equation 7.

The latitude and the longitude which define the first region to the sixth region may be changed in another example embodiment. For example, the first face F1 through the sixth face F6 may be rotated on at least one of the x-axis, the y-axis and the z-axis. For example, a geographical point in the Korean Peninsula may be located at a center of the first face F1. In this case, the first face F1 may correspond to a region which is, e.g., between −10 degrees and +80 degrees in latitude and between +90 degrees and +180 degrees in longitude.

As mentioned above, the computation part 130 may convert the global coastline position data in the latitude-longitude coordinates system into coordinates in the cubed-sphere coordinates system in the step S213.

A six-panel grid frame may be defined by expanded plan view of the six faces F1, F2, F3, F4, F5 and F6 of the virtual cube 310. For example, each of the faces F1, F2, F3, F4, F5 and F6 may be defined by four sub-faces of eight sub-cubes SC1, SC2, SC3, SC4, SC5, SC6, SC7 and SC8 which are assembled with each other within the virtual cube 310. Each of the sub-cubes SC1, SC2, SC3, SC4, SC5, SC6, SC7 and SC8 may include a first vertex, a second vertex, a third vertex and a fourth vertex. The first vertex may be the center C of the Earth. The second vertex, the third vertex and the fourth vertex may be spaced apart from the center C of Earth by a predetermined distance (e.g., small “a” distance) along the x-axis, the y-axis and the z-axis respectively, in a positive direction or in a negative direction.

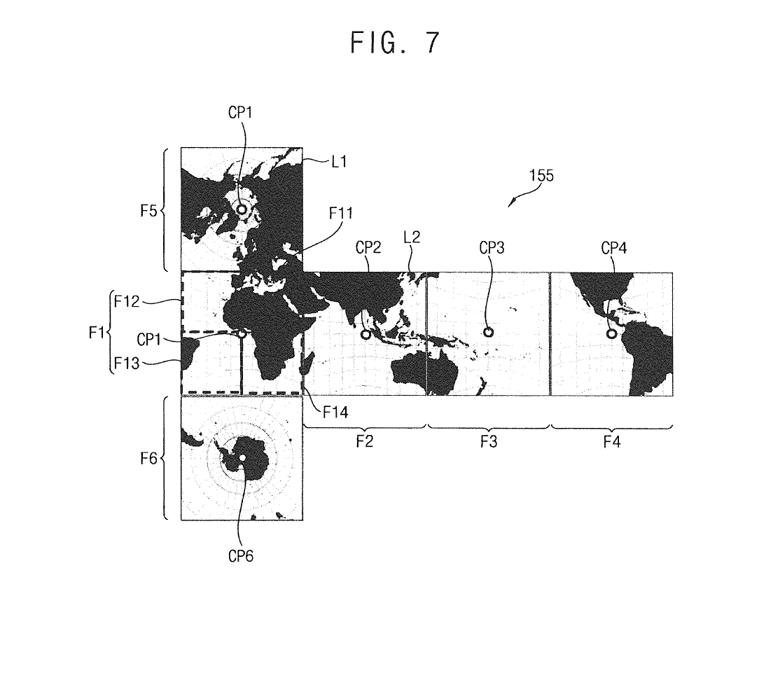

FIG. 7 is an expanded plan view illustrating global map data on a six-panel grid frame according to an example embodiment.

Referring to FIG. 7, global map data converted in the step S210 may be displayed on an expanded plan view of faces F1, F2, F3, F4, F5 and F6 of the virtual cube 310. For example, a first sub-face F11 may be located in a first quadrant of the first face F1. A second sub-face F12 may be located in a second quadrant of the first face F2. A third sub-face F13 may be located in a third quadrant of the first face F3. A fourth sub-face F14 may be located in a fourth quadrant of the first face F4. Although the fifth face F5 is connected to the first face F1 and the sixth face F6 is connected to the first face F1 in FIG. 7, the expanded plan view of the faces F1, F2, F3, F4, F5 and F6 may be altered in another example embodiment. For example, the fifth face F5 may be connected to the second face F2 in another example embodiment. In this case, a first border line L1 of the fifth face F5 may coincides with a second border line L2 of the second face F2.

The global map 155 in the six-panel grid frame illustrated in FIG. 7 may not be displayed on the display part 150 in the step S210. For example, the global map data converted into coordinates in the six-panel grid frame may be just stored in the memory 110 and then displayed on the display part 150 with numerical weather prediction model data in the step S250.

Referring to FIG. 4 again, numerical weather prediction model data computed in the computation part 130 using the cubed-sphere coordinates system may be provided for the six-panel grid frame in the step S230. In this case, the computation part 130 may adequately adjust a first grid resolution of the numerical weather prediction model data to a second grid resolution of the global map data in the six-panel grid frame. For example, if the first grid resolution of the numerical weather prediction model data is greater or lower than the second grid resolution of the global map data in the six-panel grid frame, then the numerical weather prediction model data may be interpolated and/or extrapolated to match the second grid resolution.

In the present example embodiment, an additional interpolation and/or extrapolation may not be required in the step 230 which may occur in a display process of numerical weather prediction model data in the cubed-sphere coordinates system onto an expanded plan view of the faces of the virtual cube 310.

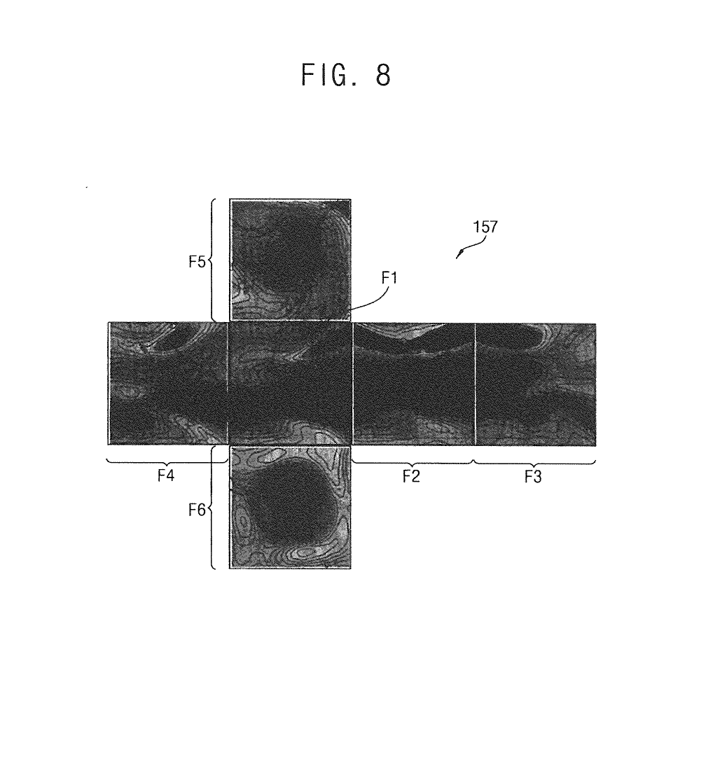

FIG. 8 is an expanded plan view illustrating a global distribution of a physical quantity in atmosphere using a six-panel grid frame according to an example embodiment.

Referring to FIG. 8, the display part 150 may display the numerical weather prediction model data on the six-panel grid frame. A global distribution 157 of an atmospheric and/or oceanic physical quantity may be displayed on the six-panel grid frame with the global map converted in the step S210. The global distribution 157 of the physical quantity may be visualized by a variety of ways such as, isopleths, shading, hue, etc.

As mentioned above, according to one or more example embodiment of the visualization method of numerical weather prediction model data on the six-panel grid frame and the hardware device performing the same, the numerical weather prediction model data which are computed in the cubed-sphere coordinates system may be displayed on the six-panel grid frame to which faces of the virtual cube in the cubed-sphere coordinates system expanded, thereby easily representing the numerical weather prediction model data without any additional coordinates conversion.

Also, an additional interpolation and/or extrapolation process may not be required to visualize the numerical weather prediction model data in the cubed-sphere coordinates system on an expanded plan view, thereby improving accuracy of the numerical weather prediction model data represented on the expanded plan view.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages of the present invention. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

[EXPLANATION ON REFERENCE NUMERALS]

| | |
|---|---|
| 100: hardware device | 110: memory |
| 130: computation part | 150: display part |

151, 153: latitude-longitude grid frame
155, 157: six-panels grid frame
F1, F2, F3, F4, F5, F6: face

What is claimed is:

1. A method of visualizing numerical weather prediction model data on a six-panel grid frame, wherein the method performed in a hardware device comprising a computation part, a memory and a display part electrically connected to both of the computation part and the memory, the computation part being configured to numerically solve a plurality of partial differential equations in a numerical weather prediction model, and the method comprising:
converting global map data from latitude-longitude coordinates into coordinates in the six-panel grid frame;
providing the six-panel grid frame with numerical weather prediction model data in a first cubed-sphere coordinates system; and
displaying the numerical weather prediction model data on the six-panel grid frame,
wherein the six-panel grid frame comprises expanded six faces of a virtual cube, each face of the expanded six faces being defined by four sub-faces of eight sub-cubes which are assembled with each other within the virtual cube, each of the sub-cubes comprising a first vertex, a second vertex, a third vertex and a fourth vertex,
wherein the second vertex, the third vertex and the fourth vertex are spaced apart from a center of Earth by a predetermined distance along an x-axis, a y-axis and a z-axis respectively, in a positive direction or in a negative direction, and the first vertex is the center of the Earth, and
wherein the x-axis, the y-axis and the z-axis are axes in a three-dimensional Cartesian coordinates system, the x-axis starting from the center of the Earth to penetrate a first point on a surface of the Earth, the y-axis being perpendicular to the x-axis in a latitude direction or in a longitude direction with respect to the first point, and the z-axis being perpendicular to both of the x-axis and the y-axis.

2. The method of claim 1, wherein the converting the global map data from the latitude-longitude coordinates into coordinates in the six-panel grid frame comprises:
providing global coastline position data in a latitude-longitude coordinates system; and
converting the global coastline position data from the latitude-longitude coordinates into coordinates in the six-panel grid frame.

3. The method of claim 2, wherein the providing the six-panel grid frame with the numerical weather prediction model data in the first cubed-sphere coordinates system comprises:
adjusting a first grid resolution of the first cubed-sphere coordinates system to a second grid resolution of a second cubed-sphere coordinates system,
wherein the global map data are defined in the second cubed-sphere coordinates system.

4. The method of claim 1, wherein the first point is an intersection point at which an equator and a prime meridian cross.

5. The method of claim 4, wherein the six-panel grid frame comprises:
a first face representing a first region which is between −45 degrees and +45 degrees in latitude and between zero degree and +45 degrees or between +315 degrees and +360 degrees in longitude;
a second face representing a second region which is between −45 degrees and +45 degrees in latitude and between +45 degrees and +135 degrees in longitude;
a third face representing a third region which is between −45 degrees and +45 degrees in latitude and between +135 degrees and +225 degrees in longitude;
a fourth face representing a fourth region which is between −45 degrees and +45 degrees in latitude and between +225 degrees and +315 degrees in longitude;
a fifth face representing a fifth region which is between +45 degrees and +90 degrees in latitude and between zero degree and +360 degrees in longitude; and
a sixth face representing a sixth region which is between −90 degrees and −45 degrees in latitude and between zero degree and +360 degrees in longitude.

6. A hardware device comprising:
a memory configured to store global map data in a latitude-longitude coordinates system;
a computation part configured to convert the global map data from latitude-longitude coordinates into coordinates in a six-panel grid frame and provide the six-panel grid frame with numerical weather prediction model data in a first cubed-sphere coordinates system; and
a display part configured to display the numerical weather prediction model data on the six-panel grid frame,
wherein the six-panel grid frame comprises expanded six faces of a virtual cube, each face of the expanded six faces being defined by four sub-faces of eight sub-cubes which are assembled with each other within the virtual cube, each of the sub-cubes comprising a first vertex, a second vertex, a third vertex and a fourth vertex,
wherein the second vertex, the third vertex and the fourth vertex are spaced apart from a center of Earth by a predetermined distance along an x-axis, a y-axis and a z-axis respectively, in a positive direction or in a negative direction, and the first vertex is the center of the Earth, and
wherein the x-axis, the y-axis and the z-axis are axes in a three-dimensional Cartesian coordinates system, the x-axis starting from the center of the Earth to penetrate a first point on a surface of the Earth, the y-axis being perpendicular to the x-axis in a latitude direction or in a longitude direction with respect to the first point, and the z-axis being perpendicular to both of the x-axis and the y-axis.

7. The hardware device of claim 6, wherein the computation part is further configured to receive global coastline position data in the latitude-longitude coordinates system from the memory and convert the global coastline position data into coordinates in a second cubed-sphere coordinates system.

8. The hardware device of claim 7, wherein the computation part is further configured to adjust a first grid resolution of the first cubed-sphere coordinates system to a second grid resolution of the second cubed-sphere coordinates system.

9. The hardware device of claim 6, wherein the first point is an intersection point at which an equator and a prime meridian cross.

10. The hardware device of claim 9, wherein the six-panel grid frame comprises:
a first face representing a first region which is between −45 degrees and +45 degrees in latitude and between zero degree and +45 degrees or between +315 degrees and +360 degrees in longitude;
a second face representing a second region which is between −45 degrees and +45 degrees in latitude and between +45 degrees and +135 degrees in longitude;
a third face representing a third region which is between −45 degrees and +45 degrees in latitude and between +135 degrees and +225 degrees in longitude;
a fourth face representing a fourth region which is between −45 degrees and +45 degrees in latitude and between +225 degrees and +315 degrees in longitude;
a fifth face representing a fifth region which is between +45 degrees and +90 degrees in latitude and between zero degree and +360 degrees in longitude; and
a sixth face representing a sixth region which is between −90 degrees and −45 degrees in latitude and between zero degree and +360 degrees in longitude.
